(19) United States
(12) Patent Application Publication
(10) Pub. No.: US 2002/0094798 A1
(43) Pub. Date: Jul. 18, 2002

(54) Forming a communication network

(76) Inventors: Jukka Nurminen, Espoo (FI); Harri Korpela, Espoo (FI); Lasse Juhani Oka, Espoo (FI); Timo Jaakkola, Hyvinkaa (FI); Lajos Bajzik, Budapest (HU); Bence Kodaj, Budapest (HU); Antti Maarela, Helsinki (FI); Ari Kynaslahti, Helsinki (FI); Maunu Holma, Helsinki (FI)

Correspondence Address: ALTERA LAW GROUP, LLC, 6500 CITY WEST PARKWAY, SUITE 100, MINNEAPOLIS, MN, 55344, US

(21) Appl. No.: 10/047,375

(22) Filed: Jan. 14, 2002

Related U.S. Application Data
(63) Continuation of application No. PCT/FI01/00415, filed on May 2, 2001.

(30) Foreign Application Priority Data
May 31, 2000 (FI) 20001313

(51) Int. Cl. H04Q 7/20

(52) U.S. Cl. 455/403; 455/422; 455/446; 455/560

(57) ABSTRACT

This invention relates to the forming of a communication network. The invention offers a common arrangement and a method to handle all tasks in the process of forming a communication network. The arrangement is divided into several modules, each carrying out certain tasks. The modules interwork with each other. A user selects the modules needed for forming a network. The selection depends on the network that is formed. Routine tasks have been automated in the arrangement. An iterative forming of a network is possible. The arrangement offers an interface to existing networks.

### FIELD OF THE INVENTION

This invention concerns the forming of a communication network. In particular, the invention concerns the forming of a cellular network.

### BACKGROUND OF THE INVENTION

By viewing a process targeted to form a communication network, it is worth noticing how complex a task it is. For example, in a process of forming a cellular network, many items have to be taken care of. Base stations and mobile switching centers are located in a geographical area, radio coverage areas must be defined, equipment are chosen and configured, line-of-sight (free air space between sites) information has to be examined for radio links, paths of 2 Mbit/s and virtual containers are created, and an existing network is taken into account, just to mention a few.

A cellular network can be thousands of links in size, and there can be several technologies in the network. The process of forming a network is very much an iterative process where interrelated decisions must be made. Often the process hits to a dead end. Usually manual work, which is error-prone, is needed to set up parameters for each piece of equipment in the network. As a consequence, errors cause delays in the process under way. Sometimes penalties for missing the agreed deadlines have to be paid. To take care of the whole process of forming a cellular network is a difficult task. At present, there are many parallel arrangements to handle the process and often manual work is needed, but there is no single arrangement to handle all different tasks in the process. The objective of the invention is to alleviate drawbacks of the known solutions. This is achieved in a way described in the claims.

### SUMMARY OF THE INVENTION

The invention offers a common arrangement and a method to handle all tasks in the process of forming a communication network. The arrangement is divided into several modules, each carrying out certain tasks. The modules interwork with each other. A user selects the modules needed for forming a network. The selection depends on the network that is formed. Routine tasks have been automated in the arrangement. An iterative forming of a network is possible. The arrangement offers an interface to existing networks.

### BRIEF DESCRIPTION OF THE DRAWINGS

In the following the invention is described in more detail by means of FIGS. 1-10 in the attached drawings where,

FIG. 1 shows an example of the inventive forming process in a flowchart format,

FIG. 2 shows an example of a logical network,

FIG. 3 shows an example of logical 2 Mbit/s paths,

FIG. 4 shows an example of line systems,

FIG. 5 illustrates an example of a physical network formed in a conduit module,

FIG. 6 depicts an example of a bit template,

FIG. 7 depicts an example of a radio transmission unit and a termination unit in a BTS,

FIG. 8 illustrates an automatic creation of topology,

FIG. 9 illustrates connections in the first site corresponding the situation in FIG. 8,

FIG. 10 illustrates connections in the second site corresponding the situation in FIG. 8.

### DETAILED DESCRIPTION OF THE INVENTION

A forming process of a cellular network, for example, starts by collecting necessary information for the process. Some information, such as equipment data (names, capacities, structures etc.) can be input into the inventive arrangement beforehand. Some information is process specific so it must be input into the arrangement at the start of the process. This kind of information is: radio coverage; locations of base stations (BTS) and base station controllers (BSC), and a site survey concerning line-of-sight (LOS) information for radio links.

The arrangement comprises five necessary modules for forming a cellular network, and if needed, additional modules. The necessary modules are: cellular; conduit; 2 Mbit/s; transport; and detail module. The additional modules are: SDH module, which forms the logical virtual container connections of the network; optical network module, forming a physical network topology of an optical network by selecting the optical cross-connection and WDM equipment used; broadband module, forming logical topology of the broadband connections, and capacities of the broadband connections; signaling module, forming logical topology of the signaling connections, and capacities of the signaling connections; PSTN module, forming logical topology of the PSTN connections, and capacities of the PSTN connections; Interswitch module, forming logical connections between logical connections of different technologies used; TETRA module, forming logical topology of the TETRA connections, and capacities of the TETRA connections; IP module, forming IP addressing and DCN (Data Communications Network) for the network management; ATM module forming VCCs (Virtual Circuit Connections), VPCs (Virtual Path Connections), and links between adjacent ATM equipment; and lightpath module, forming a physical network topology of lightpaths selecting the equipment used.

The additional modules are needed, for example, if the cellular network comprises optical paths.

A forming process of a network is not a simple task. The process (and the network) can be divided into many layers, such as physical and logical layers. The physical layer describes a real physical network, where nodes and lines have been located. The logical layer describes logical connections, how a single node (for example a base station) sees the network, i.e. depicts transparent connections. All layers have to be taken into account in making a working network. It is practical to organize the process so that a specific module handles a certain layer of a network.

The cellular module represents the logical layer of the network, i.e. the mobile switching centers (MSC), base stations, and base stations controllers with their logical connections. The main tasks of the cellular module are calculation of capacities and creation of BSC and MSC clusters, i.e., which BTS's are connected to which BSC, and which BSCs are connected to which MSC. The conduit module represents the physical network: sites (nodes and conduit branches); conduits; number of fibers/wires/radio links inside conduits; and line-of-sights information. The 2 Mbit/s module represents the G704 frames in the network, i.e. the logical 2 Mbit/s paths among nodes. These paths are formed in this module. The allocation of ET-ports (exchange terminals) in a BSC and the time slot allocation of the 2 Mbit/s paths are also done in this module. The transport module is a more detailed representation of the physical network. This module shows more detailed information from nodes and radio links, such as names and types of the equipment. The transport module is used interactively with other modules, in an iterative way, to decide which nodes are connected together and how. Transmission media (radio link, wire, fibre) is selected in this module in relation to the selection of equipment. The detail module creates a detailed topology of a network. Physical connections are done in the equipment port level. External ports are connected among piece of equipment. Internal 2 Mbit/s cross-connections of equipment are made for transit and terminating traffic. In the terminating traffic, 2 Mbit/s connections are the basis for 8 kbit/s connections. 8 kbit/s connections are created according to bit templates of 2 Mbit/s paths. The detail module offers an automated creation of a detailed topology.

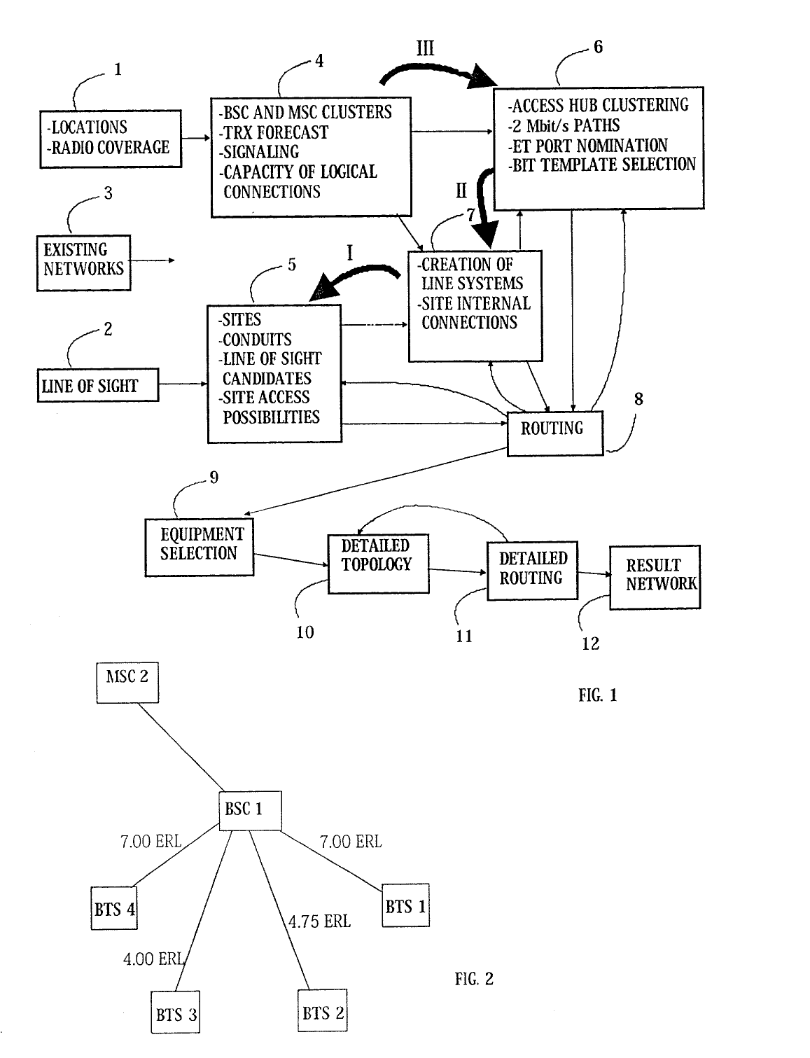

FIG. 1 represents an example of a cellular network forming process according to the invention. The process starts by importing information of radio coverage and locations (1) of BTS's and BSC's into the cellular module (4) where BSC and MSC clusters are formed and also logical connections between BTS's and BSC's, and between BSC's and MSC. Also capacities of the logical connections are calculated. The capacity calculation can be based on cells, erlangs or subscribes. The cellular module also takes into account the forecasted capacity. For example, when a base station comprises three cells in a configuration 1+1+1 TRX's (three sectors, each sector comprising one transceiver), and traffic is forecasted to grow up to 2+2+2 TRX's, the future utilization can already be taken into account in the bit allocation of 2 Mbit/s frames. (The bit allocation is created in the 2 Mbit/s module.) The signaling rate (a frame type for signaling) is selected as well. If there are existing network parts, information about them can be used as a part of the input information (3) for the cellular module, and for the other modules too. FIG. 2 shows an example of a logical network created in the cellular module.

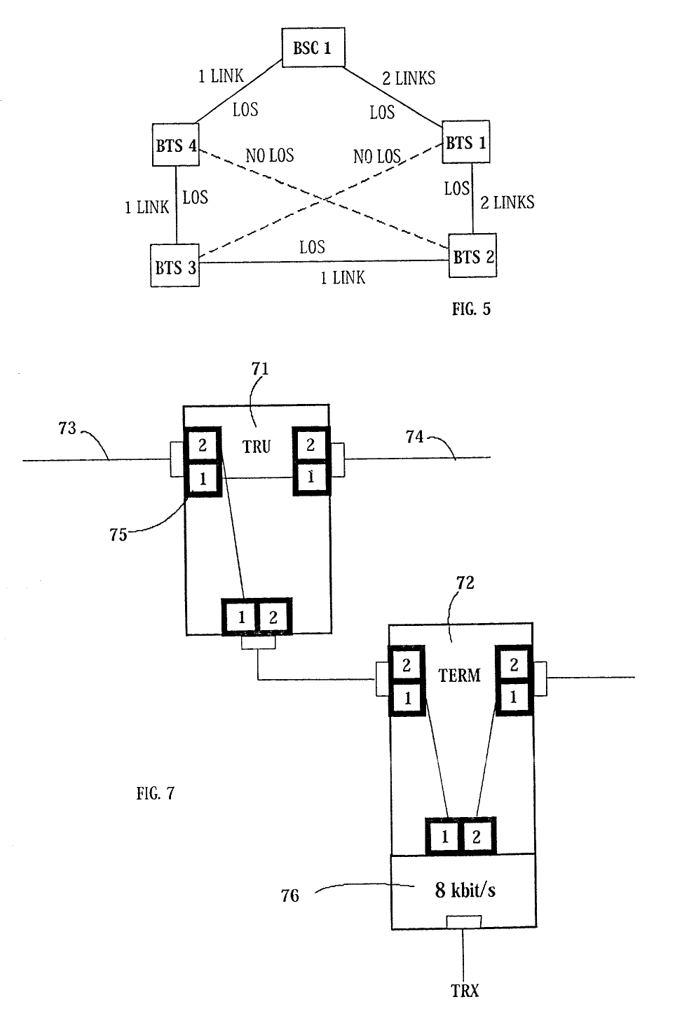

Site survey data concerning line-of-sight information (2) (FIG. 1) for radio links is the input for the conduit module (5). The locations of nodes, conduits, and conduit branches are defined in this module. The line-of-sight information and number of media (fibers, wires, radio links in a conduit) are registered in the conduit module. Information of existing networks can be used as input. FIG. 5 illustrates an example of a physical network formed in the conduit module.

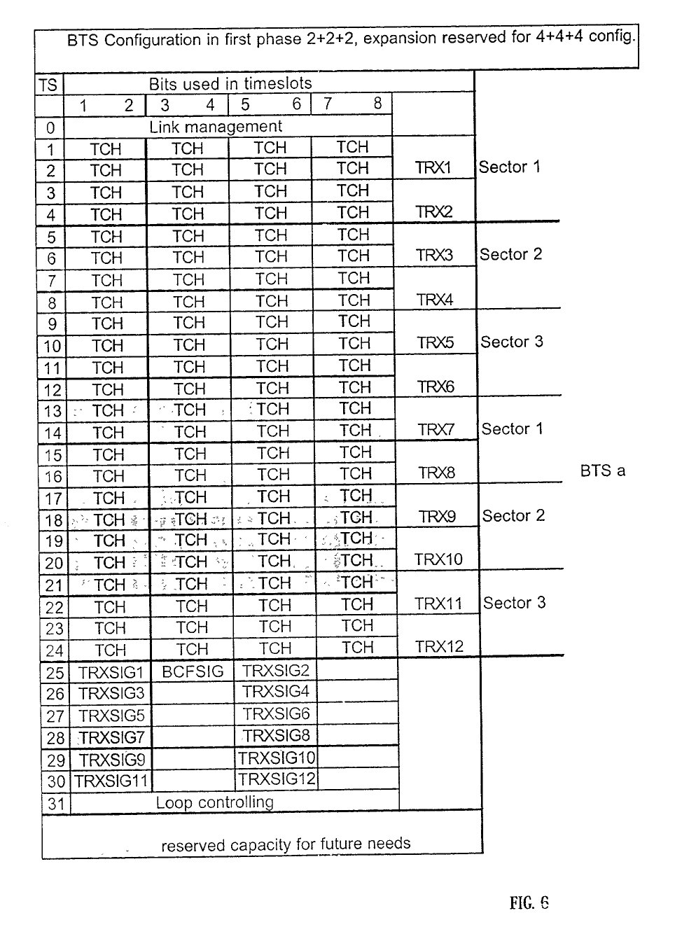

In the 2 Mbit/s module (6) (FIG. 1) logical 2 Mbit/s paths among nodes are formed. In other words, it is determined which 2 Mbit/s frame goes to which node or nodes via a logical 2 Mbit/s path. The allocation of ET-ports (exchange terminals) in a BSC, i.e. which ET-port(s) represents which BTS, is done in this module. The time slot allocation of 2 Mbit/s paths is also done by selecting a suitable bit template for each ET-port. It is worth noting that although 2 Mbit/s path structures are formed in this module, the actual equipment level connections for 2 Mbit/s paths are done in the detail module, by using the selected bit templates. Another matter worth noticing is that usually BTS's are not connected directly to the BSC, but between them there is a HUB collecting traffic from the BTS's to the BSC. Also HUB clusters are formed in the 2 Mbit/s module. FIG. 3 shows an example of logical 2 Mbit/s paths. Notice that a user can think about protection frames as well. FIG. 6 depicts an example of a bit template used in time slot allocation.

Sometimes a new cellular network is designed to comprise SDH nodes and links. In this case the SDH module is used to form logical VC-4 paths and SDH nodes.

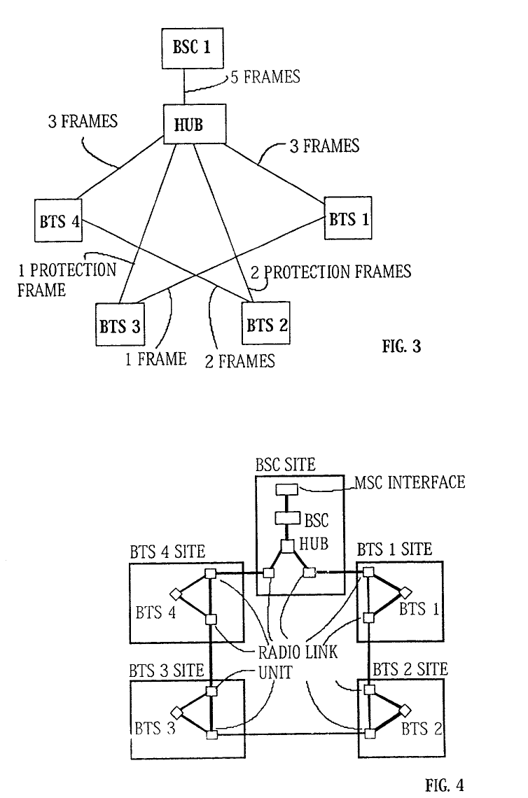

In the transport module (7) (FIG. 1) nodes and radio links are selected, i.e. each equipment type and product is defined. By selecting equipment, the detailed internal structure is also selected, which information is used in the detail module. The transport module is used interactively with other modules, in an iterative way, to decide which nodes are connected together and how. Transmission media (radio link, wire, fibre or leased line), capacity and type (e.g. STM-4, STM-16) are selected in this module. The types (SDH or PDH) of line systems among nodes are selected as well. The transport module can also be used for early routing, without other modules, such as the conduit or 2 Mbit/s module. This is a typical situation in an early phase of forming a network for understanding roughly capacities needed. FIG. 4 shows an example of line systems formed in the transport module.

In the transport module it is possible to select automatic, semiautomatic of manual routing. Generally, the term routing describes choosing a data stream path (connection) between two endpoints. In this text routing also means a process to route the whole network or a specific network part, i.e. to route all data streams in a network or in a specific network part. The routing processes (8) (FIG. 1) bind the modules to each other. FIG. 1 shows information flows among the modules, carrying the routing and other necessary information. In other word the flows describe inputs from one module to another. The iteration flows are depicted in curved dashed lines. The thick solid lines marked with roman numbers represents routing orders.

It is convenient to think of a network as layers on top of one another, each layer representing a specific task area of the network. The modules represent these layers. On the top there is a logical connection level (the cellular module) and on the bottom there is a physical layer (the conduit module). Between these layers there can be several sublayers, the number of them depending on the network structure. In the case of a cellular network, usually there are needed two sublayers: a line system layer (the transport module) representing a more detailed structure of the physical network, and a 2 Mbit/s layer (the 2 Mbit/s module) representing logical 2 Mbit/s paths. The routing order is from bottom to top, so that the first layer above the bottom layer is routed to the bottom layer, the second layer above the bottom layer is routed to the first layer above the bottom layer, and so on until the top layer is routed to the layer below. The routing order is marked in roman numbers in FIG. 1. This means that links in the line systems (the transport module) are routed (I) to the conduits (the conduit module), logical 2 Mbit/s paths (the 2 Mbit/s module) are routed (II) to the line systems, and logical connections (the cellular module) are routed (III) to the logical 2 Mbit/s paths. When routing traffic the protection aspect can also be taken into account, i.e. routing a primary and secondary path for a channel. It can be said that the routing of a specific layer to the layer below corresponds to using the resources of the layer below, i.e. the layer below offers resources for the layer above it.

It must be remembered that the process of forming a network has an iterative nature. So, there is no need to do all before-mentioned tasks, before the routing actions can be done. The routing actions need topology and capacity information from the conduit, 2 Mbit/s, and transport modules. Thus the equipment selection (9) (FIG. 1) can be done after the routing actions in the transport module (5).

After the routing actions and the equipment selection, the detail module (10) (FIG. 1) creates a detailed topology of the network. Physical connections are done in an equipment port level. External ports are connected among pieces of equipment. Internal 2 Mbit/s cross-connections of equipment are done for transit and terminating traffic. In the terminating traffic, 2 Mbit/s connections are the basis for 8 kbit/s connections. 8 kbit/s connections are created according to bit templates, such as in FIG. 6. FIG. 7 depicts an example of a radio transmission unit (71) and a termination unit (72) in a BTS. The radio link (73) transfers 2 Mbit/s paths (frames) to and from the adjacent BTS in the other end of the radio link. The radio bus (74) transfers by-pass traffic to another radio transmission unit in the other side of the BST. The capacity of this BTS is 2*2 Mbit/s frames. Frames are depicted as numbered boxes (75) in the interfaces of the radio transmission unit and the termination unit. Frame 1 is cross-connected through the BTS, but frame 2 is terminated in the termination unit. The termination unit is connected to the 8 kbit/s card (76), which handles cross-connections between the terminated 2 Mbit/s frame and 8 kbit/s channels for one or more TRX.

The detail module offers an automated creation of a detailed topology. Requirements for the automatic topology generation are: the routing process must be completed in the transport and 2 Mbit/s modules; logical paths must be routed to sublevels (such as conduit module); and ET port allocation must be made in the 2 Mbit/s module.

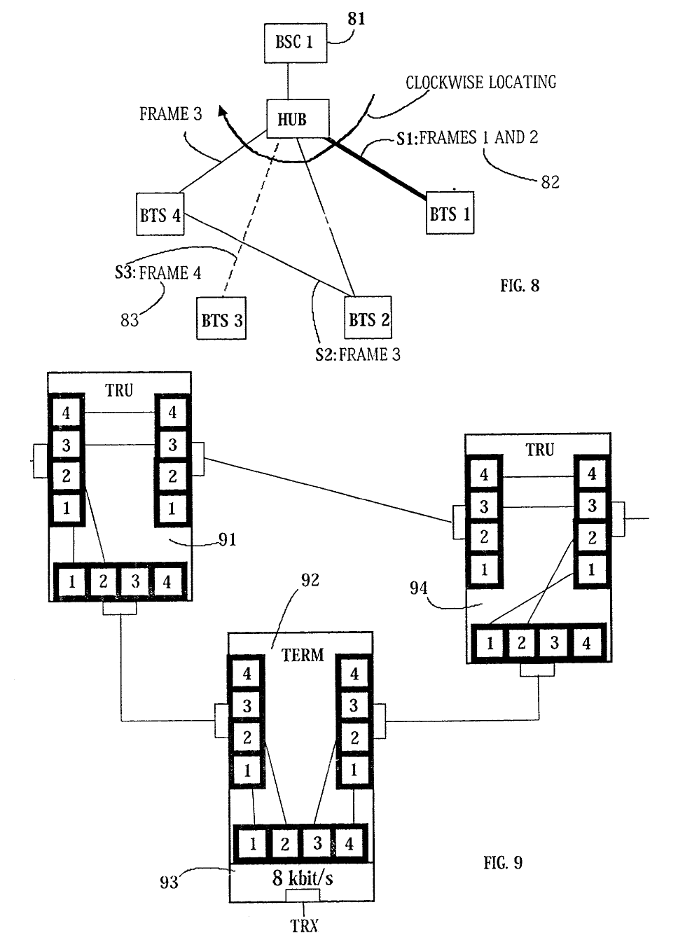

The automatic topology creation is done in the following way. Path subsystems are formed in a way that FIG. 8 illustrates. Chains or loops of 2 Mbit/s logical paths (frame/s) from the BSC (81) form the path subsystems. The subsystems (S1, S2, S3) (and frames) are labeled clockwise from the view of the BSC, starting from frame 1 (82) and ending at the last frame (83). In sites path subsystems remain in their places in the radio frame; the first sub-system (frame one) in slot one, the second (frame two) in slot two etc. In other words, the first subsystem is located into timeslot one in the radio frame, the second subsystem into slot two etc. The first path subsystem is terminated at the first site clockwise from the BSC. Other path subsystems pass through. In the site, where the second sub-system is terminated, the 2 Mbit/s frames of the second subsystem are dropped down and terminated. Other sub-systems are passed through the BST. In this way the inventive arrangement automatically selects default settings for 2 Mbit/s and 8 kbit/s cross-connections between radio link frames and transceiver unit interfaces in each site.

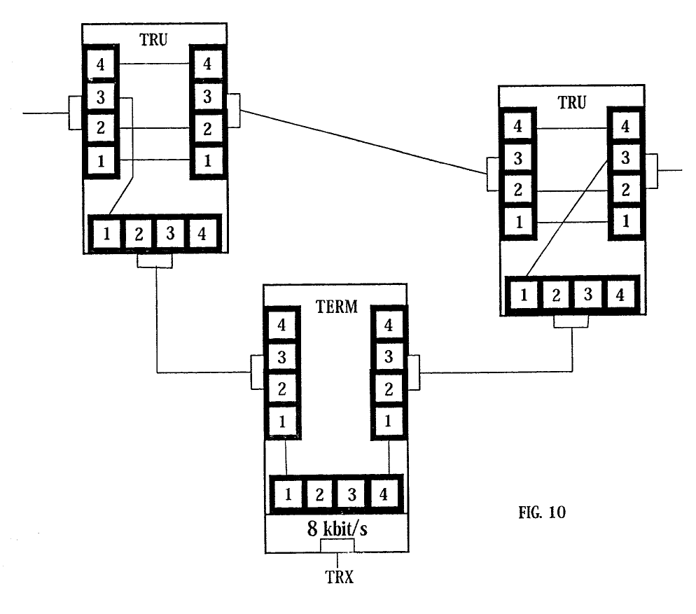

FIG. 9 illustrates connections in the first site corresponding to the situation in FIG. 8 where the first two 2 Mbit/s frames form the first subsystem. The radio transmission unit (91) transfers traffic between the BSC and itself. The first two 2 Mbit/s frames are dropped down and connected to the termination unit (92) which transfers the 2 Mbit/s frames to the 8 kbit/s card (93). The transmission card is also connected to the other radio transmission unit (94) transferring traffic to and from another BTS. (Notice that FIG. 8 shows the logical connections, but physical traffic goes through physical radio links and transmission units.) Frames 3 and 4 are cross-connected through the first site (BST 1). FIG. 10 shows the cross-connections in the second side (BTS 2) in FIG. 8 where frame 3 is terminated and the other frames pass through, even if the other frames are not in use in radio links connected to the second site (Frames 1 and 2 were terminated in first site.). Notice in FIG. 8 that only the part of 2 Mbit/s frame 3 is connected to TRX's in the second site, and the rest of 2 Mbit/s frame 3 is connected to TRX's in BTS 4, if both the BTS's are active.

After the routing, equipment selection and creating of the detailed topology, detailed routing (11) (FIG. 1) is done, also in the detail module. The detailed routing checks the created topology of the detail module and cross-connection in nodes, comparing them against the routing made before. The detailed routing does not add or modify the logical connection or 2 Mbit/s paths. However, endpoints for 2 Mbit/s frames are added if they are missing and primary/secondary 2 Mbit/s frame endpoints are swapped (dropped down or by-passed) if necessary. After the detailed routing, the network has formed (12) (FIG. 1), and implementation can be done.

It is also worth mentioning that the arrangement according to the invention is capable of forming a 3G (third generation) network. The forming of the 3G network uses at least the cellular module, IP module, ATM module, conduit module, 2 Mbit/s module, SDH module, and transport module. The site survey data is fed into the conduit module. The cellular module gets the radio plan from a planning tool, such a tool being WCDMA (Wideband Code Division Multiple Access) specific, or alternatively a rough plan is created in the cellular model itself.

The cellular model divides the traffic into a control plane (AAL5 traffic) and a user plane (AAL 2 traffic), which are fed into the ATM module. The ATM module creates topologies of VCCs (Virtual Circuit Connections) and VPCs (Virtual Path Connections). Further, the ATM module forms links between adjacent ATM equipment. For making capacity calculations easier, a CAC (Connection Admission Control) algorithm is used when a new AAL2 connection is created to existing ATM VCCs.

The IP module forms IP addressing and a DCN (Data Communications Network) for the network management. The DCN connections are preferably better to plan before forming line systems in the SDH, 2 Mbit/s, and transport modules. The DCN connections, namely, have a great effect on the ATM cross connection tables.

End-to-end delays are calculated after the creation of the ATM topology and the line system, and are compared with the delay requirements. After this comparison, i.e. checking, configuration files for AXCs (ATM Cross Connects) can be generated.

The inventive arrangement forms an interactive environment, where the network topology and routes are made one layer at a time. It is possible to start with a simple topology, for example with only one layer (such as the physical one), and add the intermediate layers forming their topology gradually on top of another. It is worth noticing that a network can contain several technologies, so there must be several modules to form logical connections for each technology, i.e. there can be several top modules, whose connections are routed into layers below. The main idea is to leave all important decisions for the (experienced) user while the arrangement helps in tedious routine issues. The invention can preferably be realized by software. Although the invention is described in the light of the cellular network example, it is obvious that the invention can be used to form other types of communication networks as well. In other cases, a suitable set of modules for forming a network must be selected. Thus the invention is not restricted to the example above, but it can be used in other solutions as well, in the scope of the inventive arrangement.

1. An arrangement for forming a communications network, characterized in that the arrangement comprises several modules which transfer relevant information between each other, each module handling the forming of a part of the network to be formed, a set of the modules, selected for forming the communications network, handling together the forming of the communications network.

2. An arrangement according to claim 1, characterized in that the set of the modules is arranged from the bottom module, which forms a physical topology of the network, to the top module, which forms logical connections of the network, so that the modules between the bottom and top module form either physical topologies of the network based on specific technologies, or logical connections of the network based on the specific technologies, each module offering resources for the module above, and each module using resources from the module below.

3. An arrangement according to claim 2, characterized in that the distinct bottom module forms physical nodes, conduits, and conduit branches, the conduits containing a number of fibers, wires, or radio links, the physical topology containing line-of-sights information concerning the radio links.

4. An arrangement according to claim 2, characterized in that the distinct top module forms MSC and MSC clusters, and capacities of the logical connections.

5. An arrangement according to claim 2, characterized in that between the bottom and top modules there is the module which forms logical 2 Mbit/s connection of the network.

6. An arrangement according to claim 5, characterized in that the module further forms 2 Mbit/s frame allocation for exchange terminals in a specific BSC, and selects bit templates for each allocation.

7. An arrangement according to claim 2, characterized in that between the bottom and top modules there is the module which forms logical virtual container connections of the network.

8. An arrangement according to claim 2, characterized in that between the bottom and top modules there is the module which forms a physical network topology by selecting the equipment used.

9. An arrangement according to claim 2, characterized in that between the bottom and top modules there is the module which forms a detailed physical network topology in the equipment level by selecting the connections inside equipment, and between equipment.

10. An arrangement according to claim 9, characterized in that the module creates the detailed topology automatically.

11. An arrangement according to claim 2, characterized in that the distinct top module forms logical topology of the broadband connections, and capacities of the broadband connections.

12. An arrangement according to claim 2, characterized in that the distinct top module forms logical topology of the signaling connections, and capacities of the signaling connections.

13. An arrangement according to claim 2, characterized in that the distinct top module forms logical topology of the PSTN connections, and capacities of the PSTN connections.

14. An arrangement according to claim 2, characterized in that the distinct top module forms logical topology of the TETRA connections, and capacities of the TETRA connections.

15. An arrangement according to claim 2, characterized in that the distinct top module forms logical topology of the connections of the 3G network, and capacities of the 3G network connections.

16. An arrangement according to claim 2, characterized in that the distinct top module forms logical connections between logical connections of different technologies used.

17. An arrangement according to claim 2, characterized in that between the bottom and top module there is the module which forms a physical network topology of lightpaths selecting the equipment used.

18. An arrangement according to claim 2, characterized in that between the bottom and top module there is the module which forms the physical network topology of an optical network by selecting the optical cross-connection and WDM equipment used.

19. An arrangement according to claim 2, characterized in that between the bottom and top module there is the module which forms an IP network topology.

20. An arrangement according to claim 2, characterized in that between the bottom and top module there is the module which forms an ATM network topology by creating virtual circuit connections, virtual path connections, and links between adjacent ATM equipment.

21. An arrangement according to claim 2, characterized in that connections of each module are routed separately to the module below, from bottom to top, so that the first module above the bottom module is routed to the bottom module, the second module above the bottom module is routed to the first module above the bottom module, and so on until the top module is routed to the module below.

22. A method for forming a communications network, characterized in that the method comprises the steps of:
establishing parts of tasks, each part containing a specific technology area to form logical connections of the network, or to form a physical topology of the network,
arranging automatically the parts from the bottom part, which forms a physical topology of the network, to the top part, which forms logical connections of the network, so that the parts between the bottom and top part form either physical topologies of the network based on specific technologies, or logical connections of the network based on specific technologies,
creating topologies and connections in each part,
routing connections of each part separately to the part below, from bottom to top, so that the first part above the bottom part is routed to the bottom part, the second part above the bottom part is routed to the first part above the bottom part, and so on until the top part is routed to the part below.

23. A method according to claim 19, characterized in that the part which automatically forms a detailed physical cellular network topology in the equipment level by selecting the connections inside equipment, and between equipment comprises the steps of:
forming chains or loops of 2 Mbit/s logical paths, which paths contain one or more 2 Mbit/s frames, from a BSC, clockwise from the view of the BSC,
labeling the 2 Mbit/s logical paths clockwise from the view of the BSC, starting from the first frame and ending at the last frame,
connecting first 2 Mbit/s logical path into transceivers, and bypassing the other 2 Mbit/s logical paths in the first BTS clockwise from the view of the BSC,
connecting second 2 Mbit/s logical path into transceivers, and bypassing the other 2 Mbit/s logical paths in the second BTS clockwise from the view of the BSC, and so on until
connecting the last 2 Mbit/s logical path into transceivers, and bypassing the other 2 Mbit/s logical paths in the last BTS clockwise from the view of the BSC.
